(19) United States
(12) Patent Application Publication
(10) Pub. No.: US 2025/0229657 A1
(43) Pub. Date: Jul. 17, 2025

(54) VEHICLE WITH ELECTRIC CONNECTOR

(71) Applicant: KAWASAKI MOTORS, LTD., Akashi-Shi (JP)

(72) Inventors: Kota HIDAKA, Akashi-Shi (JP); Hidefumi YASUHARA, Akashi-Shi (JP); Ryo SEKOGUCHI, Akashi-Shi (JP)

(73) Assignee: KAWASAKI MOTORS, LTD., Akashi-Shi (JP)

(21) Appl. No.: 18/413,243

(22) Filed: Jan. 16, 2024

(51) Int. Cl. B60L 53/16; B60R 16/033; H01R 13/52

(52) U.S. Cl. CPC B60L 53/16; B60R 16/033; H01R 13/5227; B60L 2200/22

(57) ABSTRACT

A vehicle with an electric connector includes a car body, wheels rotatably supported by the car body, a traveling battery supplying travel drive power, a seat, and a dashboard. The dashboard includes a dashboard body located in front of the seat and a charging electric connector supported by the dashboard body to receive electric power for the traveling battery.

### FIELD OF THE INVENTION

The present disclosure relates to a vehicle with an electric connector for electrical connection from outside.

### DESCRIPTION OF THE BACKGROUND ART

U.S. Pat. No. 9,216,637 B2 discloses an electric vehicle with a connector for charging.

U.S. Pat. No. 9,653,842 B2 discloses a vehicle with a USB connector.

### SUMMARY

According to one aspect, a vehicle with an electric connector is a vehicle including: a car body; wheels rotatably supported by the car body; a traveling battery supplying travel drive power; a seat; and a dashboard including a dashboard body located in front of the seat and a charging electric connector supported by the dashboard body to receive electric power for the traveling battery.

According to this vehicle, the charging electric connector receiving the electric power for the traveling battery is supported by the dashboard body, thus a driver easily recognizes whether or not charging is being performed.

According to another aspect, the vehicle includes: a car body; wheels rotatably supported by the car body; a steering control steering the wheels; a seat located in back of the control; and an external apparatus electric connector including a connection port, wherein an extension part extending to a side of an opening of the connection port in a plan view is located on an upper side of the connection port.

According to this vehicle, water and dust, for example, hardly enters the connection port by the extension part.

According to still another aspect, a vehicle includes: a car body; wheels rotatably supported by the vehicle body; a steering control located to one of both sides in a vehicle-width direction to steer the wheels; a seat located in rear of the control; and a dashboard including a dashboard body located in front of the seat, a driver seat-side external apparatus electric connector supported by the dashboard body on a side closer to the steering control in relation to a middle in the vehicle-width direction, and a passenger seat-side external apparatus electric connector supported by the dashboard body on a side opposite to the steering control in relation to the middle in the vehicle-width direction.

According to this vehicle, occupants seated to right and left sides of the seat can easily use the external apparatus electric connector.

The objects, features, aspects, and advantages of this disclosure will become more apparent from the following detailed description and the accompanying drawings.

### BRIEF DESCRIPTION OF THE DRAWINGS

FIG. 1 is a side view illustrating a vehicle.

FIG. 2 is a perspective view illustrating a dashboard.

FIG. 3 is a back view illustrating the dashboard.

FIG. 4 is a partial perspective view of the dashboard.

FIG. 5 is a side view illustrating the dashboard.

FIG. 6 is a perspective view illustrating a rearward portion of a seat.

### DESCRIPTION OF THE PREFERRED EMBODIMENTS

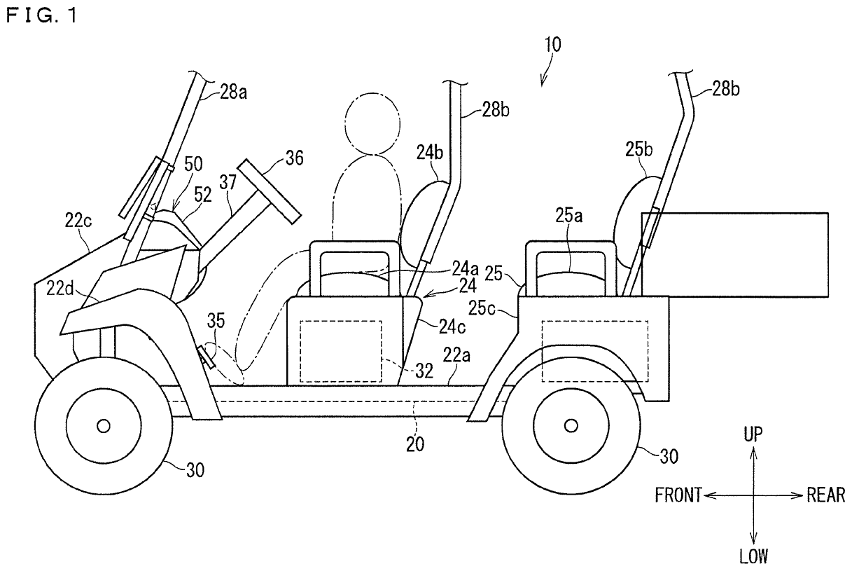

A vehicle with an electric connector according to an embodiment is described hereinafter. FIG. 1 is a side view illustrating a vehicle 10. In the following description, traveling directions of the vehicle 10 may be expressed as frontward, rearward opposite to the frontward direction, downward toward road surfaces on which the vehicle 10 travels, and upward opposite to the downward direction. The right and left may be referred to while a person stands on a road surface and faces frontward. The lateral direction is a vehicle-width direction.

A whole configuration of a vehicle is described. The vehicle 10 may be an occupant transport vehicle designed to travel at low speeds within a limited area.

The vehicle 10 may be, for example, an off-road vehicle. The off-road vehicle may be a versatile small vehicle suitable for off-road travel rather than for fast travel on a public road.

Examples of the off-road vehicle include a side-by-side vehicle. The side-by-side vehicle is, for example, a small vehicle suitable for all terrain travel, and a vehicle in which occupants can be seated side by side. The side-by-side vehicle may be, for example, a multipurpose off-highway utility vehicle (MOHUV) defined by ANSI/OPEI B71.9-2016, and a recreational off-highway vehicle defined by ANSI/ROHVA 1-2016.

Examples of the limited area may include limited community areas, private roads, and private lands (e.g., golf courses and parks). The limited community areas are areas provided for use by community residents. The community areas are, for example, areas including houses and public facilities (e.g., schools and hospitals), and are areas in which the vehicle designed to travel through non-public highways are permitted to travel at low speeds. The low speeds are, for example, speeds with upper limits ranging from 20 mph to 30 mph. Examples of the vehicle 10 include personal transport vehicles (PTVs) in accordance with ANSI/ILTVA Z135, and golf carts in accordance with ANSI/ILTVA Z130.1. The examples of the vehicle 10 include personal transportation electric vehicles.

The vehicle 10 may be a vehicle in which at least two occupants can ride side by side. The vehicle 10 may be opened outside of seats 24 and 25 in a vehicle-width direction without being obstructed by walls or doors to facilitate the occupants getting on or off the vehicle 10. Here, the occupants can walk past in a lateral direction without being obstructed by doors or walls.

The vehicle 10 includes a car body 20, wheels 30, a traveling battery 32, the seats 24 and 25, and a dashboard 50.

The car body 20 may have a frame structure or a monocoque structure. For example, when the car body 20 has a frame structure, the car body 20 includes a frame and panels. The frame is structured by combining, for example, metallic pipe components, sheet metal components, or cast components. The panels cover the frame and various components supported by the frame. The panels give the appearance of the vehicle 10, and partition spaces in the vehicle 10. Examples of the panels include a floor panel 22a, the dashboard 50, a hood 22c, and fenders 22d. The floor panel 22a is located at the bottom of the space for occupants. The floor panel 22a constitutes a floor of the present vehicle 10. The dashboard 50 is more frontward than the seats 24 and 25. The hood 22c is more frontward than the dashboard 50. The hood 22c externally covers a support mechanism of the front wheels 30. The fenders 22d are located at outside portions of the hood 22c in the lateral direction, and cover the front wheels from above with some space.

Each of the seats 24 and 25 is a part on which an occupant is to be seated. The seats 24 and 25 are located on the floor panel 22a and behind the dashboard 50. The car body 20 supports the seat 25 at a position on an upper side of the floor panel 22a.

The seats 24 and 25 are spaced apart from each other in a frontward and rearward direction. The seat 24 is more frontward than the seat 25.

The seat 24 includes a seat cushion 24a, a back rest cushion 24b, and a seat base 24c. The seat base 24c supports the seat cushion 24a at a position on an upper side away from the floor panel 22a. The back rest cushion 24b is supported in an upright attitude behind the seat cushion 24a. The dashboard 50, which is more frontward than the seat 24, faces the seat 24. The occupant seated on the seat 24 is accessible to at least a rear portion of the dashboard 50.

The seat 24 is a seat on which at least two occupants can be seated side by side. In this case, the seat cushion 24a may be continuous in the vehicle-width direction, or separated in the middle in the lateral direction. This embodiment describes an example where the seat cushion 24a is a bench seat continuous in the vehicle-width direction. The back rest cushion 24b may also be continuous in the vehicle-width direction, or separated to the right and left.

In the similar manner, the seat 25 includes a seat cushion 25a, a back rest cushion 25b, and a seat base 25c. The seat base 25c supports the seat cushion 25a at a position away behind the seat 24 and above the floor panel 22a. The occupant can be seated on the seat cushion 25a while the feet are placed between the seat cushions 24a and 25a.

The seat 25 may be a bench seat or separated to the right and left. The rear seat 25 may be omitted. The rear seat 25 may consist of seats in the frontward and rearward direction.

Outside portions of the seats 24 and 25 in the vehicle-width direction are openings through which occupants get on or off the vehicle 10. The vehicle 10 is intended to normally travel with the openings being opened and not closed by, for examples, doors. Both outer sides of a space between a rearward portion of the dashboard 50 and the front seat 24 in the vehicle-width direction may be opened outward without being closed by panels, for example.

The wheels 30 are supported by the car body 20 to be rotatable. The four wheels 30 are located, for example, at four corners of the car body 20. The wheels 30 support the car body 20 on a road surface. The rotation of the wheels 30 on a road surface enables the car body 20 to travel on the road surface. The number of the wheels 30 is discretionary. The vehicle may be, for example, a three-wheel vehicle or a six-wheel vehicle.

A travel driving mechanism should rotationally drive the wheels 30. The travel driving mechanism includes a traveling motor 31 and a power transmission mechanism. Transmission of rotation drive force of the traveling motor 31 to the wheels 30 through the power transmission mechanism allows the vehicle 10 to travel.

The structure of the power transmission mechanism is discretionary. Examples of the power transmission mechanism may include a transmission and a drive shaft. The power transmission mechanism may drive only the rear wheels, only the front wheels, or all the wheels.

The two front wheels 30 are rotatable around its own central axis and are supported to be rotatable around a steering axis, at right and left front portions of the car body 20. The two rear wheels 30 are supported to be rotatable around its own central axis at right and left rear portions of the car body 20.

The traveling motor 31 is an electric motor that converts electric energy into rotational motion for traveling. Thus, the vehicle 10 includes a traveling battery 32 supplying travel drive power to the traveling motor 31. For example, the traveling battery 32 is supported at a lower portion of the seat 24, and the traveling motor 31 is supported at a lower portion of the seat 25. The traveling battery 32 may be a lead battery, a lithium-ion battery, or a nickel-metal-hydride rechargeable battery, for example. As described in this embodiment, the vehicle 10 for transporting occupants which includes the traveling motor 31 that is an electric motor is an electric occupant transport vehicle.

The positions of the traveling motor 31 and the traveling battery 32 are discretionary. For example, the traveling motor may be disposed on a front side of the vehicle. The traveling battery may be disposed on a front side or a rear side of the vehicle, or a lower side of the floor panel.

The vehicle may be a hybrid vehicle in which travel drive force of an electric motor and travel drive force of an internal combustion engine are combined. In this case, the vehicle may include a fuel tank.

The dashboard 50 is more frontward than the seats 24 on which a driver is seated. The frame structure of the car body 20 and a support structure and wiring parts of the front wheels 30 are disposed in front of the dashboard 50. The support structure of the wheels 30 is, for example, the rack and the pinion for steering and a suspension. The dashboard 50 can function as a partition between an area for occupants to be seated on the seat 24, and the frame structure, the support structure, and the wiring parts. That is to say, the dashboard 50 covers the frame structure, the support structure, and the wiring parts from the rear side so that the occupants to be seated on the seat 24 cannot see the frame structure, the support structure, and the wiring parts.

The vehicle 10 may include a steering control 36. The steering control 36 is a control for steering the wheels 30. In this embodiment, the steering control 36 steers the front wheels 30. The steering control may steer the rear wheels, or the front and rear wheels.

The steering control 36 is a handle for receiving a driving operation from the driver. The steering control 36 may be, for example, shaped like a wheel. The steering control 36 is supported to be rotatable by a steering column 37. The steering control 36 is supported at a position behind the dashboard 50. Thus, the seat 24 is more rearward than the steering control 36. The steering control 36 is supported at a position on one of the right and the left with respect to a middle in the vehicle-width direction.

This embodiment describes an example where the vehicle 10 is a left-steering vehicle in which the driver is seated on the left. Thus, the steering control 36 is supported at a position on the left with respect to the middle in the vehicle-width direction. The driver seated to the left of the front seat 24 can operate the steering control 36. Thus, the steering control may be supported at a position on the right with respect to the middle in the vehicle-width direction.

The rotation operation of the steering control 36 is transmitted to the front wheels 30 via, for example, the steering column 37 and a rack and a pinion. This can steer the wheels 30 in both the right and the left directions. The steering column 37 may include a switch or a display.

Pedals 35 are located below the steering control 36. The pedals 35 are, for example, an accelerator pedal and a brake pedal. The pedals 35 may be an accelerator pedal and a brake pedal that are separately provided. The number of the pedals 35 may be one that receives both operations of an accelerator and a brake.

The pedals 35 are located on one side with respect to the middle in the vehicle-width direction. The pedals 35 are located to the same side of the steering control 36 with respect to the middle in the vehicle-width direction. In this embodiment, the pedals 35 are located on the left side with respect to the middle in the vehicle-width direction. The pedals 35 may be located on the right side with respect to the middle in the vehicle-width direction.

The vehicle 10 may not include the steering control 36. For example, when the vehicle 10 is automatically driven or remotely operated, the steering control 36 may be omitted. In the similar manner, the pedals 35 may be omitted.

The vehicle 10 may include pillars 28a, 28b, and 28c. The pillars 28a, 28b, and 28c are pillars supported upright by the car body 20. The pillar 28a, the pillar 28b, and the pillar 28c may include two right and left front pillars 28a, two right and left center pillars 28b, and two right and left rear pillars 28c, respectively.

The two right and left front pillars 28a are the pillars 28a rising upward through outside positions of the dashboard 50 in the vehicle-width direction. The two right and left front pillars 28a may rise upward through outside front portions of the dashboard 50 in the vehicle-width direction. The two right and left front pillars 28a may rise upward to lean rearward at positions above the dashboard 50. A front windshield may be supported between the two right and left front pillars 28a.

The front pillars 28a may be more rearward than the hood 22c. The right and left floor panel 22a and the front windshield may be located along a boundary between the hood 22c and the dashboard 50.

The two right and left rear pillars 28c rise upward from a rear portion of the car body 20. The two right and left rear pillars 28c rise upward, for example, via behind the back rest cushion 25b.

The two right and left center pillars 28b are located between the front pillars 28a and the rear pillars 28c in the frontward and rearward direction. The two right and left rear pillars 28c rise upward, for example, via behind the back rest cushion 24b.

The front pillars 28a, the center pillars 28b, and the rear pillars 28c may be referred to as A pillars, B pillars, and C pillars, respectively.

The pillars 28a, 28b, and 28c may support a roof or a top frame. The number and positions of the pillars 28a, 28b, and 28c are discretionary. For example, the center pillars 28b may be omitted.

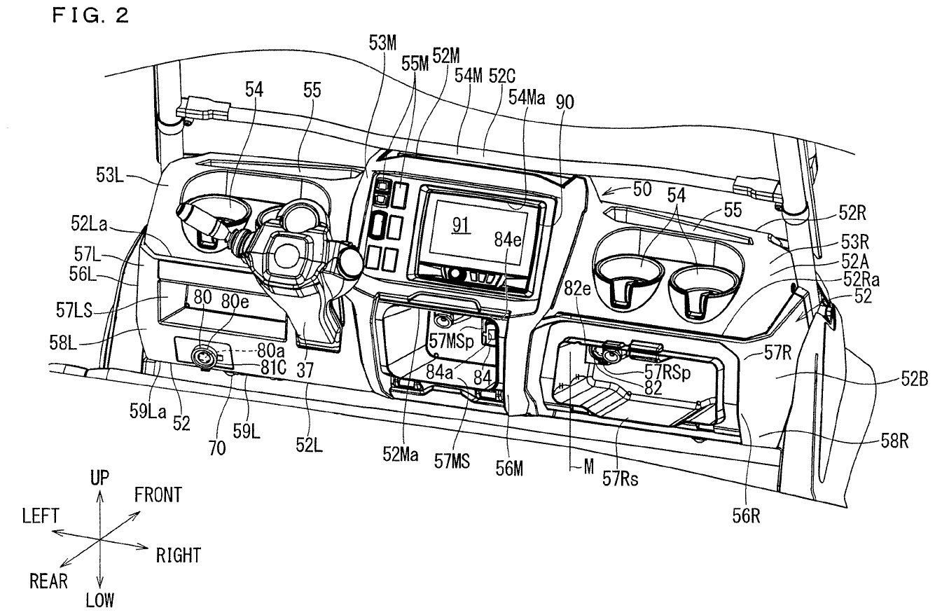

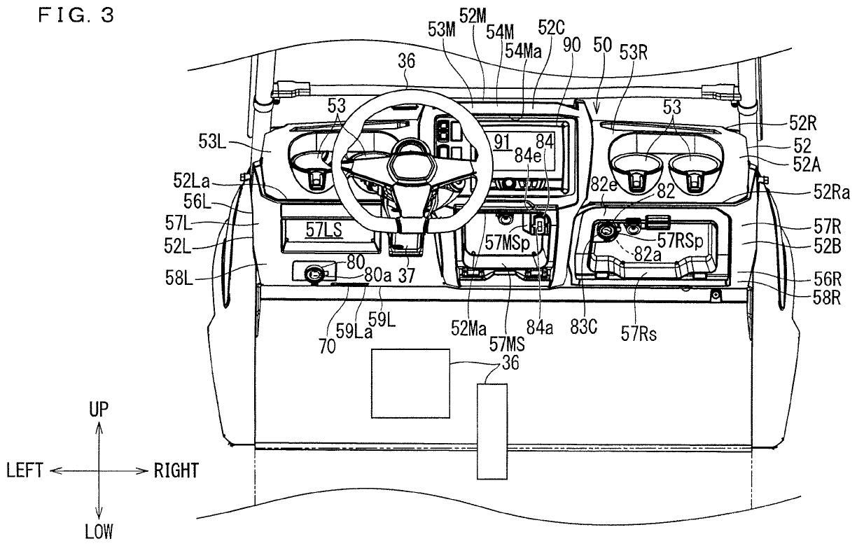

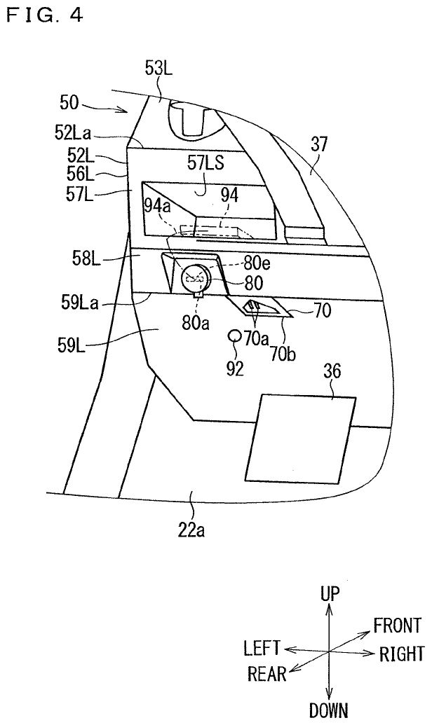

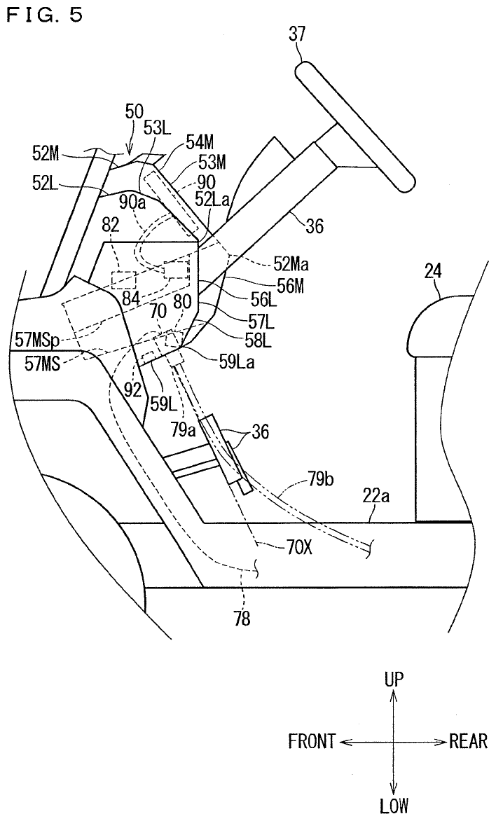

The dashboard 50 will be described. FIG. 2 is a perspective view illustrating the dashboard 50. The steering control 36 is omitted in FIG. 2. FIG. 3 is a back view illustrating the dashboard 50. FIG. 4 is a partial perspective view of the dashboard 50. FIG. 5 is a side view illustrating the dashboard 50.

The dashboard 50 includes a dashboard body 52 and a charging electric connector 70.

The dashboard body 52 is more rearward than the front wheels 30 and the support mechanism of the front wheels 30. The dashboard body 52 is more rearward than the hood 22c. The dashboard body 52 is more frontward than the front seat 24. The dashboard body 52 partitions the front wheels 30 and the support mechanism of the wheels 30, and the space for the occupants to be seated on the front seat 24.

The dashboard body 52 may include a left portion 52L, a middle portion 52M, and a right portion 52R. One of the left portion 52L and the right portion 52R is a portion closer to the steering control 36 in the vehicle-width direction, that is, a portion in front of the driver. In this embodiment, the left portion 52L is the portion in front of the driver. The right portion 52R is a portion in front of an occupant to be seated next to the driver. The middle portion 52M is a portion in the middle of the dashboard body 52 in the vehicle-width direction, that is, a portion between the driver and the occupant.

The left portion 52L in a side view includes a curved portion whose middle portion bulges the most rearward in the vertical direction. In a side view of the left portion 52L, an edge 52La is located closer to an upper side of the curved portion. The edge 52La extends along the vehicle-width direction. An upper portion of the left portion 52L with respect to the edge 52La extends diagonally upward and frontward. A lower portion of the left portion 52L with respect to the edge 52La extends downward. An upper portion of the left portion 52L with respect to the edge 52La is a left upper portion 53L, and a lower portion of the left portion 52L with respect to the edge 52La is a left lower portion 56L.

The left upper portion 53L includes a sloped portion extending diagonally upward and frontward, and a front portion extending frontward from a front edge of the sloped portion.

A cup holder 54 is located in the sloped portion. Two cup holders 54 may be disposed side by side. The cup holder 54 is shaped like a cup supporting a cup from a lower side. The cup holder 54 supports the cup for the driver. A tray 55 is located in front portion. The tray 55 is shaped like a shallow dish. For example, the tray 55 supports goods of the driver.

The hood 22c is located more frontward than the front portion of the left upper portion 53L. The front windshield partitions the space above the front portion and the space above hood 22c.

The left lower portion 56L extends diagonally downward and frontward from the edge 52La. The space in which the feet of the occupant are placed is formed under the left lower portion 56L.

The left lower portion 56L includes a first region 59L, a second region 58L, and a rearward region 57L in this order from the lower side toward the edge 52La. The rearward region 57L is a portion extending to the lower side from the edge 52La. The second region 58L is a portion extending diagonally downward and frontward from a lower end edge of the rearward region 57L. The first region 59L is a portion extending diagonally downward and frontward from a lower end edge of the second region 58L. The rearward region 57L, the second region 58L, and the first region 59L have a slope angle increasing in this order with respect to a perpendicular direction.

A driver seat-side storage 57LS is disposed in the rearward region 57L. The driver seat-side storage 57LS is shaped like a rectangular parallelepiped box, and has a quadrangular opening elongated in the vehicle-width direction. An opening of the driver seat-side storage 57LS is opened toward a rear side at a position on an outer side of the steering column 37 in the rearward region 57L in the vehicle-width direction. The driver seat-side storage 57LS forms a housing space extending frontward from the opening of the rearward region 57L. The rearward region 57L is directed rearward, thus the opening of the driver seat-side storage 57LS is also directed rearward. Thus, the driver can easily have access to the driver seat-side storage 57LS from the rear side at a position on both outer sides of the steering column 37 in the vehicle-width direction.

A driver seat-side external apparatus electric connector 80 is located in the second region 58L. The charging electric connector 70 is located in the first region 59L.

The left portion 52L and the right portion 52R may have an outer shape symmetric with respect to a middle M in the vehicle-width direction. The middle M is, for example, a surface in the direction of gravity which passes through the middle between the right front wheel and the left front wheel and the middle between the right rear wheel and the left rear wheel.

Thus, the right portion 52R may include a right upper portion 53R, an edge 52Ra, and a right lower portion 56R, similarly to the left portion 52L.

Similarly to the left upper portion 53L, it is applicable that the right upper portion 53R includes a sloped portion and a front portion, the sloped portion includes a cup holder 54, and the front portion includes the tray 55.

The right lower portion 56R may include a passenger seat-side storage 57RS different from the driver seat-side storage 57LS.

For example, the right lower portion 56R includes a first region 59R, a second region 58R, and a rearward region 57R in this order from the lower side toward the edge 52Ra similarly to the left lower portion 56L.

The passenger seat-side storage 57RS may be disposed in the rearward region 57R and the second region 58R. The passenger seat-side storage 57RS is shaped like a rectangular parallelepiped box larger than the driver seat-side storage 57LS, and has a quadrangular opening elongated in the vehicle-width direction. An opening of the passenger seat-side storage 57RS is opened toward a rear side in the rearward region 57R and the second region 58R. The passenger seat-side storage 57RS forms a housing space extending frontward from the opening of the rearward region 57L and the second region 58R. The rearward region 57R the second region 58R are directed rearward, thus the opening of the passenger seat-side storage 57RS is also directed rearward. Thus, the occupant can easily have access to the passenger seat-side storage 57RS from the rear side.

The charging electric connector 70 is not included as with the left lower portion 56L, thus the passenger seat-side storage 57RS and the opening thereof can be easily set large.

The driver seat-side storage 57LS or the passenger seat-side storage 57RS may be inclined diagonally downward toward the front side. Accordingly, an object in the driver seat-side storage 57LS or the passenger seat-side storage 57RS hardly gets outside. The opening of the driver seat-side storage 57LS or the passenger seat-side storage 57RS may be closed by a openable cover.

The left portion and the right portion may not be bilaterally symmetric. For example, a slope angle of the sloped portion or a shape of the sloped portion or a spreading portion of the front portion may not be the same as each other.

The middle portion 52M is located between the left portion 52L and the right portion 52R. A proportion of the middle portion 52M to the dashboard body 52 is discretionary. FIG. 2 and FIG. 3 illustrate an example where the left portion 52L, the middle portion 52M, and the right portion 52R account for the respective regions obtained by dividing the dashboard body 52 into three equal parts in the vehicle-width direction.

The middle portion 52M in a side view includes a curved portion which protrudes more than the left portion 52L and the right portion 52R and whose middle portion bulges the most rearward in the vertical direction. In a side view of the middle portion 52M, a portion of the middle portion 52M which protrudes the most rearward is an edge 52Ma. The edge 52Ma extends along the vehicle-width direction.

An upper portion of the middle portion 52M with respect to the edge 52Ma is a middle upper portion 53M, and a lower portion of the middle portion 52M with respect to the edge 52Ma is a middle lower portion 56M.

The middle upper portion 53M includes a sloped portion 54M facing diagonally upward and rearward. The sloped portion 54M extends diagonally upward and frontward from the edge 52Ma.

The sloped portion 54M protrudes more than the sloped portions located to the right and left outside the sloped portion 54M. An opening 54Ma into which an information apparatus 90 can be incorporated is formed in the sloped portion 54M. The information apparatus 90 incorporated into the sloped portion 54M faces diagonally upward and rearward. Since the information apparatus 90 faces diagonally upward and rearward with respect to the edge 52Ma, the information apparatus is easily seen and operated by both of the driver and the occupant.

The information apparatus 90 may be an apparatus that can display information and can be operated. The information apparatus 90 may be, for example, an apparatus including a touch panel 91 that displays information and receives a touch operation. The information apparatus 90 may be, for example, an entertainment information apparatus such as audio equipment, or a navigation apparatus. The audio equipment may be, for example, an apparatus including an amplifier circuit and operation functions for playing music. The information apparatus 90 may be connectable to an external apparatus possessed by the occupant. For example, a smart phone or a tablet terminal may be connected to the information apparatus 90 through a USB cable or via Bluetooth communication. The information apparatus 90 may display information regarding traveling of the vehicle 10 such as a speed, a traveling distance, or a remaining amount of the traveling battery 32, for example.

The middle portion 52M may include a switch 55M for operating the respective units of the vehicle 10. The middle portion 52M may include, for example, the switches 55M for switching various lights of the vehicle 10 and switches 55M for changing emission directions of the lights.

The front portion may further extend frontward from a front side edge of the sloped portion 54M. The tray 55 opening upward may be formed in the front portion.

The middle lower portion 56M extends diagonally downward and frontward from the edge 52Ma. The middle lower portion 56M protrudes more than the left lower portion 56L and the right lower portion 56R.

A middle storage 57MS is disposed in the middle lower portion 56M. The middle storage 57MS is shaped like a rectangular parallelepiped box, and has a quadrangular opening elongated in the vehicle-width direction. An opening of the middle storage 57MS is opened toward a rear side in a region closer to the edge 52Ma in the middle lower portion 56M. The middle storage 57MS forms a housing space extending frontward from the opening in the middle lower portion 56M. A region in the middle lower portion 65M closer to the edge 52Ma is directed rearward, thus the opening of the middle storage 57MS is also directed rearward. Thus, both the occupants riding in the driver seat and the passenger seat can easily have access to the middle storage 57MS from the rear side.

The space in which the feet of the occupant are placed is also formed under the middle lower portion 56M. Since the space in which the feet of the occupants can be placed is formed under the left lower portion 56L, the middle lower portion 56M, and the right lower portion 56R in the vehicle-width direction, the occupants easily get on or off the vehicle 10.

The middle portion 52M may be omitted, and the left portion 52L and the right portion 52R may be directly connected.

The dashboard body 52 may be a combination of components, or a single component. In this embodiment, the dashboard body 52 includes an upper dashboard body 52A, and a lower dashboard body 52B under the upper dashboard body.

The upper dashboard body 52A is obtained by integrally molding the left upper portion 53L, the right upper portion 53R, and the front portion of the middle upper portion 53M closer to the front side using a resin. The lower dashboard body 52B is obtained by integrally molding the left lower portion 56L, the right lower portion 56R, and the middle lower portion 56M closer to the front side using a resin.

A portion of the middle portion 52M except for a portion integrally formed with the upper dashboard body 52A and the lower dashboard body 52B may be molded as a middle dashboard body 52C separately from the upper dashboard body 52A and the lower dashboard body 52B.

In other words, the left portion 52L has a structure divided into the left upper portion 53L and the left lower portion 56L by the edge 52La. The right portion 52R has a structure divided into the right upper portion 53R and the right lower portion 56R by the edge 52Ra. Furthermore, the left upper portion 53L and the right upper portion 53R are integrally formed by connection through an upper front portion of the middle portion 52M. Furthermore, the left lower portion 56L and the right lower portion 56R are integrally formed by connection through a lower front portion of the middle portion 52M. The middle portion 52M is incorporated into a middle region enclosed by the upper dashboard body 52A and the lower dashboard body 52B.

The upper dashboard body 52A, the lower dashboard body 52B, and the middle dashboard body 52C are joined together so that the respective mating surfaces are closed, and supported by the frame of the car body 20.

When a dashboard body is structured from a combination of components, the divided structure is not limited to the aforementioned example. For example, the middle dashboard body 52C may be integrally formed into the upper dashboard body 52A or the lower dashboard body 52B.

The description hereinafter is focused on the charging electric connector 70. The dashboard 50 includes the charging electric connector 70. The charging electric connector 70 is a connector receiving electric power for the traveling battery 32. The charging electric connector 70 is connected to the traveling battery 32 via a charging wiring 78 and a charging circuit. The electric power supplied to the charging electric connector 70 is supplied to the traveling battery 32 via the charging wiring 78 and the charging circuit. Accordingly, the traveling battery 32 is charged.

The dashboard body 52 supports the charging electric connector 70. Herein, the dashboard body 52 is located in front of the driver seated on the seat 24 for the driver. Thus, when the driver seated on the seat 24 is directed frontward to drive the vehicle, the driver easily recognizes presence of a charging plug 79a and a charging cable 79b connected to the charging electric connector 70. Accordingly, the driver easily recognizes whether or not the charging is being performed.

The dashboard body 52 preferably supports the charging electric connector 70 in a downward posture with respect to a horizontal direction. The charging electric connector 70 preferably has a posture inclined with respect to the perpendicular direction. It is preferable that the charging electric connector 70 is directed to the floor panel 22a as a floor, and an axis line extended line 70X of the charging electric connector 70 intersects with the floor panel 22a.

More specifically, the charging electric connector 70 is a connector including a charging terminal 70a and a housing 70b surrounding the charging terminal 70a. The housing 70b has an opening, and the charging terminal 70a is exposed outside through the opening. The charging plug 79a is connected to an end portion of the charging cable 79b extending from a charging facility in a charging station. The charging plug 79a is connected to the charging electric connector 70, thus electric power for charging is supplied to the charging terminal 70a.

The charging electric connector 70 is supported in the first region 59L in the left lower portion 56L. For example, an attachment piece extending outside from the opening of the housing 70b is disposed along the first region 59L to be attached to the first region 59L. Accordingly, the charging electric connector 70 is supported in the first region 59L.

The opening of the charging electric connector 70 is directed to the same direction as an outward surface of the first region 59L. That is to say, the axis line extended line 70X of the charging electric connector 70 follows a normal line of the outward surface of the first region 59L. The axis line extended line 70X of the charging electric connector 70 is parallel to a direction of connection of the charging plug 79a to the charging electric connector 70. The axis line extended line 70X of the charging electric connector 70 follows a direction of extension of a portion of the charging terminal 70a to the charging plug 79a.

As described above, the outward surface of the first region 59L is directed diagonally downward and rearward. Thus, the charging electric connector 70 also has a downward posture with respect to the horizontal direction. The charging electric connector 70 is directed downward with respect to the horizontal direction, thus water or dust dropping in accordance with gravity hardly enters the charging electric connector 70. The charging cable 79b extending from the charging electric connector 70 easily interferes with feet of the occupant intending to enter between the seat 24 and the dashboard 50, and the occupant easily recognizes that the charging is being performed also from this point.

The charging electric connector 70 may be directed diagonally downward or immediately below. However, the charging electric connector 70 preferably has a posture inclined with respect to the perpendicular direction, that is to say, directed diagonally downward as with this embodiment. It is considered that the charging plug 79a from outside is connected to the charging electric connector 70 more easily when the charging electric connector is directed diagonally downward than a case where the charging electric connector is directed immediately below.

It is more preferable that the axis line extended line 70X of the charging electric connector 70 intersects with the floor panel 22a. In this case, for example, the charging cable 79b extending from the charging plug 79a easily extends along the axis line extended line 70X as much as possible. Thus, the charging cable 79b is easily disposed on the floor panel 22a. The charging cable 79b is disposed on the floor panel 22a, thus the charging cable 79b easily interferes with feet of the occupant intending to enter between the seat 24 and the dashboard 50, and the occupant easily recognizes that the charging is being performed.

A floor light 92 may be disposed near the charging electric connector 70 in the dashboard 50. For example, the floor light 92 may be disposed in the first region 59L. The floor light 92 is disposed at a position illuminating the charging cable 79b while being directed to the same direction as the charging electric connector 70, thus the occupant easily recognizes the charging cable 79b, and easily recognizes that the charging is being performed.

A position where the charging electric connector 70 is supported in the dashboard body 52 is discretionary. The charging electric connector 70 may be supported at a position of having contact with the edge 59La between the second region 58L and the first region 59L, for example.

Specifically, the outward surface of the first region 59L is directed downward with respect to rearward along the horizontal direction. Thus, the outward surface of the first region 59L is out of a line of vision of a charging operator around the vehicle 10 or on the floor panel 22a, thus it is hard for the operator to visually see the charging electric connector 70.

The second region 58L is continuous on the upper side of the first region 59L via the edge 59La. The edge 59La is located on the rear side of the first region 59L, thus the position of the edge 59La is easily estimated. When the operator gropes for the dashboard body 52, the operator can tactually grasp the edge 59La.

The charging electric connector 70 is supported at a position of having contact with the edge 59La in the first region 59L. Thus, the charging electric connector 70 is disposed near the seat 24 to which the operator can easily have access in the first region 59L. The charging operator can easily grasp the position of the charging electric connector 70 using the edge 59La as a trace.

The state where the charging electric connector 70 is supported at a position of having contact with the edge 59La indicates that the charging electric connector 70 is supported at a position near the edge 59La to such an extent the charging electric connector 70 can be easily grasped using the edge 59La as a trace. Thus, the state where the charging electric connector 70 is supported at a position of having contact with the edge 59La includes not only a case where the charging electric connector 70 has direct contact with the edge 59La but also a case where a gap equal to or smaller than 5 cm, preferably a gap equal to or smaller than 3 cm, or more preferably a gap equal to or smaller than 1 cm is located between the charging electric connector 70 and the edge 59La.

The position of the charging electric connector 70 in the vehicle-width direction is discretionary. As described above, when the steering column 37 is located to one side in the vehicle-width direction with respect to the middle in the vehicle-width direction, the charging electric connector 70 may be located closer to one side in the vehicle-width direction than the steering column 37. That is to say, the charging electric connector 70 may be located on the outer side of the steering column 37 in the vehicle-width direction. In this case, the charging operator located on an outer lateral side of the vehicle 10 can easily have access to the charging electric connector 70 and perform an operation of attaching and detaching the charging cable 79b.

The charging electric connector 70 may be located on one side in the vehicle-width direction with respect to a pedal 35 for a drive operation, that is to say, the outer side of the pedal 35.

In this case, the charging operator located on an outer lateral side of the vehicle can easily have access to the charging electric connector 70 and perform an operation of attaching and detaching the charging cable 79b. When the driver operates the pedal 35 for the drive operation, the driver easily interferes with the charging plug 79a and the charging cable 79b extending from the charging electric connector 70, and easily recognizes that the charging is being performed.

The charging electric connector 70 may be supported at a position on a side of the passenger seat in the dashboard body 52.

According to the vehicle 10 including the charging electric connector 70 supported as described above, the charging electric connector 70 is supported by the dashboard body 52, thus a driver easily recognizes whether or not charging is being performed. For example, when the charging electric connector is provided to the rear portion of the front seat or the rear seat, there is a possibility that the driver seated on the driver seat hardly recognizes the charging electric connector visually, and hardly recognizes whether or not charging is being performed. The charging plug 79a is connected to the charging electric connector 70 supported by the dashboard body 52, the driver seated on the seat 24 can naturally recognize the charging plug 79a and charging is being performed.

When applied is a configuration that the rear seat can be deformed for putting a luggage, there is a possibility that accessibility to the charging electric connector supported by the rear portion of the front seat or the rear seat is deteriorated. When the charging electric connector 70 is supported by the dashboard body 52, easily achieved are both achievement of a deformation configuration of the rear seat and accessibility to the charging electric connector 70.

When the charging electric connector 70 is directed downward with respect to the horizontal direction, dropping water or dust hardly enters the opening of the charging electric connector 70. Accordingly, it is easy to make a good connection between the charging electric connector 70 and the charging plug 79a. Particularly, when the rear side and the lateral side of the dashboard 50 are opened outside, there is a possibility that water or dust adheres to the dashboard 50. When the charging electric connector 70 is directed downward with respect to the horizontal direction, water or dust hardly adheres to the charging electric connector 70.

When the charging electric connector 70 has the posture inclined with respect to the perpendicular direction, the charging plug 79a is connected to the charging electric connector 70 more easily than a case where the connecter is directed immediately below.

When the axis line extended line 70X of the charging electric connector 70 intersects with the floor panel 22a, the charging plug 79a connected to the charging electric connector is directed to the floor panel 22a, and moreover, the charging cable 79b extending from the charging plug 79a easily pass near the upper side of the floor panel 22a. Thus, when the occupant intending to ride on the seat 24 enters feet on the floor panel 22a, the feet easily interfere with the charging plug 79a or the charging cable 79b, and the occupant easily recognizes that the charging is being performed.

When the charging electric connector 70 is supported at a position of having contact with the edge 59La in the first region 59L, the charging electric connector 70 can be disposed near the seat 24 where occupant easily has access. The position of the charging electric connector 70 can be easily grasped using the edge 59La as a trace.

When the charging electric connector 70 is located on the outer side of the steering column 37 in the vehicle-width direction, it is easily to have access to the charging electric connector 70 from outside the vehicle.

When the charging electric connector 70 is located on the outer side of the pedal 35 in the vehicle-width direction, it is easily to have access to the charging electric connector 70 from outside the vehicle. When the driver intends to have access to the pedal 35, the feet easily interfere with the charging plug 79a and the charging cable 79b extending from the charging electric connector 70, and the driver easily recognizes that the charging is being performed.

External apparatus electric connectors 80, 82, 84, and 86 included in the vehicle 10 are described.

The external apparatus electric connectors 80, 82, 84, and 86 are connectors to which external apparatuses are connected, respectively. The external apparatus is a mobile apparatus which is connected to the vehicle 10 or whose connection to the vehicle 10 is released, for example. The external apparatus may be an information apparatus including a processor. The external apparatus may be a smart phone, a tablet terminal, a foldable mobile phone, a wearable terminal, a camera, for example. The external apparatus electric connectors 80, 82, 84, and 86 and the external apparatuses may be connected to each other so as to be able to supply electric power or perform communication. The electric power supply may be an electric power supply to the external apparatuses from the external apparatus electric connectors 80, 82, 84, and 86, for example. An electric power supply source in this case may be the traveling battery 32 or the other battery different from the traveling battery 32.

As illustrated in FIG. 2 to FIG. 5, the external apparatus electric connector 80 is the driver seat-side external apparatus electric connector 80 supported by the dashboard body 52 on a side closer to the steering control 36 in relation to the middle in the vehicle-width direction. The driver seat-side external apparatus electric connector 80 is a connector mainly for the driver.

As illustrated in FIG. 2, FIG. 3, and FIG. 5, the external apparatus electric connector 82 is the passenger seat-side external apparatus electric connector 82 supported by the dashboard body 52 on a side opposite to the steering control 36 in relation to the middle in the vehicle-width direction. The passenger seat-side external apparatus electric connector 82 is a connector mainly for the occupant of the passenger seat seated next to the driver.

As illustrated in FIG. 2, FIG. 3, and FIG. 5, the external apparatus electric connector 84 is the middle external apparatus electric connector 84 supported by the dashboard body 52 between the driver seat-side external apparatus electric connector 80 and the passenger seat-side external apparatus electric connector 82 in the vehicle-width direction. The middle external apparatus electric connector 84 is considered to be used by both the driver and the occupant of the passenger seat.

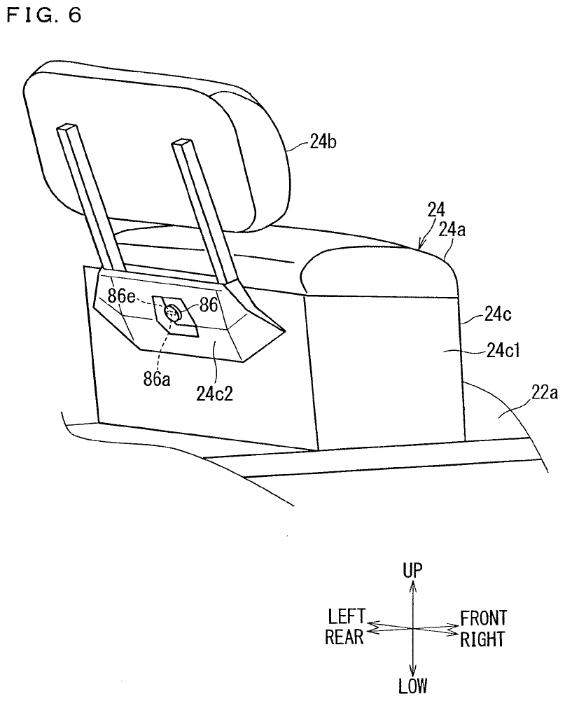

The external apparatus electric connector 86 is the rear side external apparatus electric connector 86 supported in a rearward portion of the front seat 24 as illustrated in FIG. 6. The rear side external apparatus electric connector 86 is a connector mainly for the occupant seated on the rear seat 25.

The external apparatus electric connectors 80, 82, 84, and 86 may be a universal serial bus (USB) connector. The USB connector is a connector which may be used for power source supply and signal communication. The external apparatus electric connectors 80, 82, 84, and 86 may be a connector for power source supply such as an accessary socket, for example. The external apparatus electric connectors 80, 82, 84, and 86 may be a connector for signal communication.

Each of the external apparatus electric connectors 80, 82, 84, and 86 is described more specifically.

The driver seat-side external apparatus electric connector 80 is supported by the left lower portion 56L. More specifically, the electric connector 80 is supported in the second region 58L.

As illustrated in FIG. 3, the electric connector 80 may be located on the outer side of the steering control 36 in the vehicle-width direction when seen from the rear side. For example, the electric connector 80 is located on the outer side of a portion located on an outermost side of the steering control 36 in the vehicle-width direction based on the portion. Accordingly, the steering control 36 hardly becomes an obstacle to the driver when the driver located more rearward than the steering control 36 has access to the electric connector 80.

The electric connector 80 is supported in the downward posture with respect to the horizontal direction. More specifically, the second region 58L is directed downward with respect to the horizontal direction as described above. The second region 58L is partially concaved, and the electric connector 80 is supposed in the concaved portion. A bottom portion of the concaved portion is directed downward with respect to the horizontal direction. The electric connector 80 is supported in a vertical posture with respect to the bottom portion in the bottom portion of the concave portion. Thus, the electric connector 80 is also directed downward with respect to the horizontal direction. The electric connector 80 is directed downward with respect to the horizontal direction, thus water or dust dropping in accordance with gravity hardly enters the connection port 80a of the electric connector 70, for example.

Water or dust dropping in accordance with gravity hardly enters the connection port 80a of the electric connector 80, for example, also by the configuration that the electric connector 80 is supported in the concave portion. When the driver gets on or off the seat 24, the driver hardly interferes with the electric connector 80.

In this embodiment, the electric connector 80 includes a cover 81C covering the opening thereof. It is sufficient that the cover 81C is connected to the connection port 80a of the electric connector 80 via a connection part. When the electric connector 80 is not used, the opening of the electric connector 80 is covered by the cover 81C. When the electric connector 80 is used, the cover 81C is detached from the electric connector 80, and is held while being hanging down from the opening of the electric connector 80. For example, a connector on an end portion of a cable 94a extending from an external apparatus 94 housed in the driver seat-side storage 57LS is connected to the electric connector 80. The cover 81C may be omitted.

The electric connector 80 may be disposed at a position overlapped with the charging electric connector 70 or adjacent thereto in the vehicle-width direction. A direction in which the second region 58L is directed is closer to the horizontal direction than a direction in which the first region 59L is directed. Thus, the electric connector 80 is visually recognized more easily than the charging electric connector 70. The position of the charging electric connector 70 which is hard to visually recognize directly easily can be easily assumed using the position of the electric connector 80 which is visually recognized directly easily as a trace.

The electric connector 80 may have contact with the edge 59La. When the electric connector 80 has contact with the edge 59La, the position of the charging electric connector 70 having contact with the edge 59La is easily assumed. Herein, the state where the electric connector 80 has contact with edge 59La indicates a state where the electric connector 80 is located near the edge 59La to such an extent that the position of the charging electric connector 70 is easily specified using the position of the electric connector 80 as a trace. Thus, the state where the electric connector 80 has contact with the edge 59La includes not only a case where the electric connector 80 has direct contact with the edge 59La but also a case where a gap equal to or smaller than 5 cm, preferably a gap equal to or smaller than 3 cm, or more preferably a gap equal to or smaller than 1 cm is located between the electric connector 80 and the edge 59La.

The driver seat-side external apparatus electric connector 80 is preferably directed to a lower side than the passenger seat-side external apparatus electric connector 82 or the middle external apparatus electric connector 84.

The driver seat-side external apparatus electric connector 82 is supported by the right portion 52R. More specifically, the electric connector 82 is located in the passenger seat-side storage 57RS.

That is to say, as described above, the dashboard body 52 includes the passenger seat-side storage 57RS located on a side opposite to the steering control 36 in the vehicle-width direction.

An upper portion of the passenger seat-side storage 57RS partially protrudes, and the electric connector 82 is supported in the protruding portion 57RSp. More specifically, a corner portion on an upper side in the passenger seat-side storage 57RS closer to the middle in the vehicle-width direction protrudes to an inner side. The protruding portion 57RSp protrudes only on a back side, and does not protrude on an opening side in a depth direction in the passenger seat-side storage 57RS. Thus, the end portion on the opening side of the protruding portion 57RSp is located closer to the back side in relation to the opening of the passenger seat-side storage 57RS.

The electric connector 82 is attached to the protruding portion 57RSp so that the connection port 82a of the electric connector 82 is located in the end portion of the protruding portion 57RSp on the opening side. Thus, the connection port 82a of the electric connector 80 is located closer to the back side in relation to the opening of the passenger seat-side storage 57RS in the passenger seat-side storage 57RS.

The connection port 82a of the electric connector 80 is preferably located closer to the back side in relation to the middle M of the passenger seat-side storage 57RS in the depth direction. Accordingly, a volume of protrusion of the protruding portion 57RSp covering and supporting the electric connector 82 in the passenger seat-side storage 57RS can be reduced, and a space in the passenger seat-side storage 57RS can be easily widened.

For example, a connector on an end portion of a cable extending from an external apparatus housed in the passenger seat-side storage 57RS may be connected to the electric connector 82. The electric connector 82 may include a cover 83C covering the opening thereof similarly to the electric connector 80.

The passenger seat-side external apparatus electric connector 82 is disposed in the passenger seat-side storage 57RS, thus water, for example, hardly falls on the passenger seat-side external apparatus electric connector 82 even when the passenger seat-side external apparatus electric connector 82 is directed closer to the horizontal direction than the driver seat-side external apparatus electric connector 80.

The middle external apparatus electric connector 84 is supported by the middle portion 52M. More specifically, the electric connector 84 is located in the middle storage 57MS.

That is to say, as described above, the dashboard body 52 includes the middle storage 57MS located in the middle in the vehicle-width direction.

An upper portion in the middle storage 57MS partially protrudes, and the electric connector 84 is supported in the protruding portion 57MSp. More specifically, a corner portion on an upper side in the middle storage 57MS on a side opposite to the steering control 36 protrudes to an inner side. The protruding portion 57MSp protrudes only on a back side, and does not protrude on an opening side in a depth direction in the middle storage 57MS. Thus, the end portion on the opening side of the protruding portion 57MSp is located closer to the back side in relation to the opening of the middle storage 57MS. The electric connector 84 is attached to the protruding portion 57MSp so that the connection port 84a of the electric connector 84 is located in the end portion of the protruding portion 57MSp on the opening side. Thus, the connection port 84a of the electric connector 84 is located closer to the back side in relation to the opening of the middle storage 57MS in the middle storage 57MS. Accordingly, water or dust dropping in accordance with gravity hardly enters the connection port of the electric connector 84, for example.

FIG. 5 illustrates outlines of the middle storage 57MS and the protruding portion 57MSp. FIG. 5 illustrates positions of the driver seat-side external apparatus electric connector 80, the passenger seat-side external apparatus electric connector 82, and the middle external apparatus electric connector 84.

The connection port 84a of the middle external apparatus electric connector 84 is preferably located closer to the rear side in relation to the connection port of the driver seat-side external apparatus electric connector 80 or the passenger seat-side external apparatus electric connector 82 in the frontward and rearward direction. In this embodiment, the connection port 84a of the middle external apparatus electric connector 84 is located closer to the rear side in relation to the connection ports of both the driver seat-side external apparatus electric connector 80 and the passenger seat-side external apparatus electric connector 82 in the frontward and rearward direction.

As described above, the driver seat-side external apparatus electric connector 80 is mainly used by the driver, and the passenger seat-side external apparatus electric connector 82 is mainly used by the occupant of the passenger seat. Thus, even when the electric connectors 80 and 82 are located away from the seat 24 to some extent, the electric connectors 80 and 82 can be easily used by the driver or the occupant of the passenger seat.

In contrast, the middle external apparatus electric connector 84 is assumed to be located between the driver and the occupant of the passenger seat and used by the occupants on both right and left sides. Thus, when the electric connector 84 is located near the rear side in the middle storage 57MS, the occupants on the both right and left outer sides hardly have access to the electric connector 84. Thus, when the connection port 84a of the middle external apparatus electric connector 84 is located closer to the rear side in relation to the connection port of the electric connector 80 or the electric connector 82, the occupants on the right and left sides can visually recognize the electric connector 84 easily and can have access thereto easily.

The connection port 84a of the electric connector 84 may be covered by a cover.

As described above, the information apparatus 90 is located in the middle of the dashboard body 52 in the vehicle-width direction. The middle external apparatus electric connector 84 may be communicably connected to the information apparatus 90. The connection may be performed by wire, that is to say, a wiring 90a.

When the information apparatus 90 is an apparatus used by both the driver and the occupant of the passenger seat, it is useful that the electric connector 84 is easily used from both the right and left sides. For example, there is a case where the information apparatus 90 has a processing function corresponding to an operation of the external apparatus 94. More specifically, there is a case where the information apparatus 90 has a function of playing music, a function of displaying some pieces of information for playing music, or a function of performing display for navigation.

In such a case, the information apparatus 90 may be used by the driver or the occupant of the passenger seat. Thus, when the middle external apparatus electric connector 84 communicably connected to the information apparatus 90 can be easily used from both sides in the vehicle-width direction, both the driver and the occupant of the passenger seat can easily use the information apparatus 90.

The seat 25 is located on the rear side of the front seat 24 with a distance. The rear side external apparatus electric connector 86 is supported in a rearward portion of the seat 24. Thus, the occupant seated on the rear seat 25 can easily use the rear side external apparatus electric connector 86.

More specifically, the seat 24 includes the seat base 24c as illustrated in FIG. 6. The seat base 24c protrudes on the floor panel 22a. The seat base 24c includes a box-like part 24c1 shaped like a rectangular parallelepiped box in the vehicle-width direction, for example. The seat cushion 24a is supported on the box-like part 24c1.

The rear side external apparatus electric connector 86 is supported in a rearward portion of the box-like part 24c1. For example, a bulging portion 24c2 is formed in the rearward portion of the box-like part 24cl. The bulging portion 24c2 is formed to bulge rearward in a middle portion of the rearward portion of the box-like part 24c1 in the vehicle-width direction in a region closer to an upper side. A rearward surface of the bulging portion 24c2 is formed to be directed rearward with decreasing distance to the upper side. That is to say, the rearward surface of the bulging portion 24c2 is directed diagonally rearward and downward. A pillar supporting the back rest cushion 24b extends from an upper end portion of the bulging portion 24c2.

The middle portion of the rearward portion of the bulging portion 24c2 is partially concaved, and the electric connector 86 is supposed in the concaved portion. A bottom portion of the concaved portion is directed downward with respect to the horizontal direction similarly to the other region of the rearward surface of the bulging portion 24c2. The electric connector 86 is supported in a vertical posture with respect to the bottom portion in the bottom portion of the concave portion. Thus, the electric connector 86 is also supported in a posture directed downward with respect to the horizontal direction. The electric connector 86 is directed downward with respect to the horizontal direction, thus water or dust dropping in accordance with gravity hardly enters the connection port 86a of the electric connector 76, for example. The electric connector 86 is located on a lower side of an upper end of the rearward portion of the bulging portion 24c2. Thus, in a plan view, the connection port 86a of the electric connector 86 is covered by a part of the rearward portion of the bulging portion 24c2 on an upper side of the electric connector 86. Water or dust dropping in accordance with gravity hardly enters the connection port 86a of the electric connector 86, for example, also by the configuration that the connection port 86a is covered by the upper portion of the rearward portion of the bulging portion 24c2.

Water or dust dropping in accordance with gravity hardly enters the connection port 86a of the electric connector 86, for example, also by the configuration that the electric connector 86 is supported in the concave portion of the bulging portion 24c2. When the occupant gets on or off the rear seat 25, the electric connector 86 hardly interferes with the occupant.

The electric connectors 80, 82, 84, and 86 have a configuration that an extension part extending to the opening side of the connection ports 80a, 82a, 84a, and 86a is located.

For example, the electric connectors 80 and 86 includes a housing enclosing the connection ports 80a and 86a. For example, the connection ports 80a and 86a to which a male connector on a side of a target is connected are formed in the electric connectors 80 and 86. A housing made of resin, for example, is formed to enclose the connection ports 80a and 86a.

The electric connectors 80 and 86 have the downward posture with respect to the horizontal direction, thus a portion of the housing located on the upper side of the connection ports 80a and 86a can be grasped as extension parts 80e and 86e extending to the opening side of the connection ports 80a and 86a in a plan view.

In this manner, the electric connectors 80 and 86 are directed diagonally downward, and a portion of the housing enclosing the connection ports 80a and 86a covers the connection ports 80a and 86a from the upper side as the extension parts 80e and 86e. Thus, water or dust, for example, hardly enters the connection ports 80a and 86a.

As for the electric connectors 82 and 84, the electric connectors 82 and 84 are located in the driver seat-side storage 57LS or the passenger seat-side storage 57RS. Thus, a portion of a ceiling part forming the driver seat-side storage 57LS or the passenger seat-side storage 57RS located more rearward than the connection ports 82a and 84a can be grasped as extension parts 82e and 84e extending to the opening side of the connection ports 82a, 82a, and 84a in a plan view.

In this manner, the electric connectors 82 and 84 are located in the driver seat-side storage 57LS or the passenger seat-side storage 57RS, and are covered by the extension parts 82e and 84e from the upper side, thus water or dust, for example, hardly enters the connection ports 82a and 84a. Even when the electric connectors 82 and 84 located in the driver seat-side storage 57LS or the passenger seat-side storage 57RS are not directed downward with respect to the horizontal direction, water or dust hardly enters the electric connectors 82 and 84.

The position and the posture of each of the electric connectors 80, 82, 84, and 86 are exemplification, thus there is no limitation on the position and the posture of each electric connector supported as described above.

According to the vehicle 10 including the electric connector as described above, the driver seat-side storage 57LS is supported by the dashboard body 52 closer to the steering control 36 in relation to the middle in the vehicle-width direction, and the passenger seat-side storage 57RS is supported by the dashboard body 52 on the side opposite to the steering control 36. Thus, the occupants seated to the right and left sides of the seat 24 can easily use the external apparatus electric connector 80 or the external apparatus electric connector 82.

The driver seat-side external apparatus electric connector 80 is located on the outer side of the steering control 36 in the vehicle-width direction. For example, when seen from an immediately rear side, or when seen from diagonally rear side in a direction along the steering column 37, the driver seat-side external apparatus electric connector 80 is not overlapped with the steering control 36, but is located on the outer side in the vehicle-width direction. Thus, the driver seat-side external apparatus electric connector 80 is not overlapped with the steering control 36. Accordingly, when the driver connects the external apparatus cable 94a to the driver seat-side external apparatus electric connector 80, the steering control 36 hardly becomes an obstacle to the driver.

The connection port 82a of the passenger seat-side external apparatus electric connector 82 is located in the passenger seat-side storage 57RS. Thus, the opening of the passenger seat-side storage 57RS can be widened compared with a case where a space for placing the connector for the passenger seat is provided outside the opening of the passenger seat-side storage, and the passenger seat-side storage 57RS can be easily used.

When the connection port of the passenger seat-side external apparatus electric connector 82 is located closer to the rear side in relation to the middle of the passenger seat-side storage 57RS in the depth direction, the space in the passenger seat-side storage 57RS can be widened, thus a large object or many objects can be housed therein, and such a configuration is convenient.

The connection port 84a of the middle external apparatus electric connector 84 is located in the middle storage 57MS, and is located closer to the rear side in relation to the connection ports 80a and 82a of the driver seat-side external apparatus electric connector 80 or the passenger seat-side external apparatus electric connector 82 in the frontward and rearward direction. Thus, water or dust hardly enters the connection port 84a of the middle external apparatus electric connector 84. Each of the driver and the occupant seated on the passenger seat can visually recognize and easily use the middle external apparatus electric connector 84 at the position near the opening of the middle storage 57MS. The opening itself of the middle storage 57MS can be widened, thus it is easy to take an object in and out from the middle storage 57MS.

The middle external apparatus electric connector 84 is connected to the information apparatus 90 located in the middle of the dashboard body 52 in the vehicle-width direction. The information apparatus 90 is assumed to perform information processing helpful for both the driver and passenger seat information or perform display. Thus, the middle external apparatus electric connector 84 connected to the information apparatus 90 can be easily used from both of a side of the driver seat and a side of the passenger seat, and the information apparatus 90 can also be easily used from both the side of the driver seat and the side of the passenger seat.

The rear side external apparatus electric connector 86 is supported in the rearward portion of the seat base 24c of the seat 24, thus the occupant of the rear seat 25 can use the rear side external apparatus electric connector 86, thus such a configuration is convenient.

The external apparatus electric connector 86 is supported in the downward posture with respect to the horizontal direction, thus water or dust, for example, hardly enters the connection port 86a.

According to the vehicle 10 including the electric connector, the extension parts 80e, 82e, 84e, and 86c extending to the side of the openings of the connection ports 80a, 82a, 84a, and 86a in a plan view is located on the upper side of the connection ports 80a, 82, 84a, and 86a of the electric connectors 80, 82, 84, and 86. Water or dust, for example, hardly enters the connection ports 80a, 82a, 84a, and 86a by the extension parts 80e, 82e, 84e, and 86e.

Specifically, the portion of the housing located on the upper side of the connection ports 80a and 86a in the electric connectors 80 and 86 serves as the extension parts 80e and 86e, thus water or dust, for example, hardly enters the connection ports 80a and 86a.

A part of the ceiling part of the passenger seat-side storage 57RS or the middle storage 57MS covers the connection ports 82a and 84 from the upper side as the extension parts 82e and 84e, thus water or dust, for example, hardly enters the connection ports 82a and 84a.

Particularly, when the rear side and the lateral side of the dashboard 50 and the seat 24 are opened outside, there is a possibility that water or dust adheres to the dashboard 50 or the seat 24. Adoption of the above configuration that water or dust hardly adheres to the electric connectors 80, 82, and 84 is advantageous.

The configuration according to the external apparatus electric connectors 80, 82, 84, and 86 described above may be applied to a vehicle which does not include an electric motor as a travel drive source such as an internal combustion engine vehicle, for example.

This application discloses the following aspects.

A first aspect is a vehicle with an electric connector including: a car body; wheels rotatably supported by the car body; a traveling battery supplying travel drive power; a seat; and a dashboard including a dashboard body located in front of the seat and a charging electric connector supported by the dashboard body to receive electric power for the traveling battery.

According to this vehicle, the charging electric connector receiving the electric power for the traveling battery is supported by the dashboard body, thus a driver easily recognizes whether or not charging is being performed.

A second aspect is the vehicle according to the first aspect, wherein the charging electric connector has a downward posture with respect to a horizontal direction.

Accordingly, dropping water or dust hardly enters the charging electric connector.

A third aspect is the vehicle according to the second aspect, wherein the charging electric connector has a posture inclined with respect to a perpendicular direction.

Accordingly, the charging plug is easily connected to the charging electric connector.

A fourth aspect is the vehicle according to the second or third aspect, wherein an extension of an axis line of the charging electric connector intersects with a floor of the car body.

In this case, the charging plug connected to the charging electric connector is directed to the floor, thus the charging cable extending from the charging plug also pass near the floor. Thus, when the occupant intending to ride on the seat enters feet on the floor, the feet easily interfere with the charging plug or the charging cable, and the occupant easily recognizes that the charging is being performed.

A fifth aspect is the vehicle according to any one of the second to fourth aspects, wherein the dashboard body includes a first region and a second region, an outward surface of the first region is directed downward with respect to rearward along a horizontal direction, the second region is continuous on an upper side of the first region via an edge, and the charging electric connector is supported at a position of having contact with the edge in the first region.

In this manner, when the charging electric connector is supported at a position of having contact with the edge in the first region, the charging electric connector can be disposed near the seat where occupant easily has access. The position of the charging electric connector can be easily grasped using the edge as a trace.

A sixth aspect is the vehicle according to any one of the first to fifth aspects, further including: a steering control steering the wheels; and a steering column supporting the steering control at a position on one side in a vehicle-width direction, wherein the charging electric connector is located closer to the one side in the vehicle-width direction in relation to the steering column.

Accordingly, it is easy to have access to the charging electric connector from outside the vehicle.

A seventh aspect is the vehicle according to the first to sixth aspects, further comprising a drive operation pedal located on one side in a vehicle-width direction, wherein the charging electric connector is located closer to the one side in the vehicle-width direction in relation to the drive operation pedal.

In this case, it is easy to have access to the charging electric connector from outside the vehicle. When the driver intends to have access to the drive operation pedal, the driver easily interferes with the charging plug and the charging cable extending from the charging electric connector, and easily recognizes that the charging is being performed.

An eighth aspect is the vehicle according to any one of the first to seventh aspects, further including a steering control steering the wheels, wherein the steering control is located to one of both sides in a vehicle-width direction, and a dashboard further includes: a driver seat-side external apparatus electric connector supported by the dashboard body on a side closer to the steering control in relation to a middle in the vehicle-width direction; and a passenger seat-side external apparatus electric connector supported by the dashboard body on a side opposite to the steering control in relation to the middle in the vehicle-width direction.

Accordingly, the occupants seated to each of the right and left sides of the seat can easily use the external apparatus electric connector.

A ninth aspect is the vehicle according to the eighth aspect, wherein the driver seat-side external apparatus electric connector is located on an outer side of the steering control in the vehicle-width direction.

In this case, the driver seat-side external apparatus electric connector is not overlapped with the steering control in the vehicle-width direction, thus when the driver connects the external apparatus cable to the driver seat-side external apparatus electric connector, the steering control hardly becomes an obstacle to the driver.

A tenth aspect is the vehicle according to the eighth or ninth aspect, wherein the dashboard body includes a passenger seat-side storage located on a side opposite to the steering control in the vehicle-width direction, and a connection port of the passenger seat-side external apparatus electric connector is located in the passenger seat-side storage.

In this case, the opening of the passenger seat-side storage can be widened compared with a case where a space for placing the connection port for the passenger seat-side external apparatus electric connector is provided outside the opening of the passenger seat-side storage, and the passenger seat-side storage can be easily used.

An eleventh aspect is the vehicle according to the tenth aspect, wherein a connection port of the passenger seat-side external apparatus electric connector is located closer to a rear side in relation to a middle of the passenger seat-side storage in a depth direction.

Accordingly, a space in the passenger seat-side storage can be widened.

A twelfth aspect is the vehicle according to any one of the eighth to eleventh aspects, wherein the dashboard includes a middle external apparatus electric connector supported by the dashboard body between the driver seat-side external apparatus electric connector and the passenger seat-side external apparatus electric connector in the vehicle-width direction, the dashboard body includes a middle storage located in a middle in the vehicle-width direction, and a connection port of the middle external apparatus electric connector is located in the middle storage, and is located closer to a rear side in relation to a connection port of the driver seat-side external apparatus electric connector or the passenger seat-side external apparatus electric connector in a frontward and rearward direction.

Accordingly, water or dust hardly enters the connection port of the middle external apparatus electric connector. Each of the driver and the occupant seated on the passenger seat can visually recognize and easily use the middle external apparatus electric connector.

A thirteenth aspect is the vehicle according to the twelfth aspect, wherein the dashboard further includes an information apparatus located in a middle of the dashboard body in the vehicle-width direction, and the middle external apparatus electric connector is communicably connected to the information apparatus.

Thus, the middle external apparatus electric connector connected to the information apparatus can also be easily used from both the side of the driver seat and the side of the passenger seat.

A fourteenth aspect is the vehicle according to any one of the eighth to thirteenth aspects, wherein the seat includes a seat part, a seat base supporting the seat part, and a rear side external apparatus electric connector supported in a rearward portion of the seat base.

Accordingly, a person located more rearward than the seat such as a person seated on the rear seat can use the rear side external apparatus electric connector, thus such a configuration is convenient.

A fifteenth aspect is the vehicle according to any one of the first to fourteenth aspects, further comprising an external apparatus electric connector supported in a downward posture with respect to a horizontal direction.

Accordingly, water or dust, for example, hardly enters the connection port of the external apparatus electric connector.

A sixteenth aspect is a vehicle including: a car body; wheels rotatably supported by the car body; a steering control steering the wheels; a seat located in rear of the control; and an external apparatus electric connector including a connection port, wherein an extension part extending to a side of an opening of the connection port in a plan view is located on an upper side of the connection port.

According to this vehicle, water and dust, for example, hardly enter the connection port by the extension part.

A seventeenth aspect is the vehicle according to the sixteenth aspect, wherein the external apparatus electric connector includes a housing enclosing the connection port, the external apparatus electric connector has a downward posture with respect to a horizontal direction, and a portion of the housing located on an upper side of the connection port is the extension part.

In this manner, the external apparatus electric connector has the downward posture with respect to the horizontal direction, thus water or dust, for example, hardly enters the connection port.

An eighteenth aspect is the vehicle according to the sixteenth or seventeenth aspect, further including a storage forming a space housing an object, wherein the external apparatus electric connector is located in the storage, and at least a part of a ceiling part of the storage is the extension part.

In this manner, the external apparatus electric connector is located in the storage, thus water or dust, for example, hardly enters the connection port.

A nineteenth aspect is a vehicle including: a car body; wheels rotatably supported by the vehicle body; a steering control located to one of both sides in a vehicle-width direction to steer the wheels; a seat located in rear of the control; and a dashboard including a dashboard body located in front of the seat, a driver seat-side external apparatus electric connector supported by the dashboard body on a side closer to the steering wheel in relation to a middle in the vehicle-width direction, and a passenger seat-side external apparatus electric connector supported by the dashboard body on a side opposite to the steering control in relation to the middle in the vehicle-width direction.

Accordingly, the occupants seated to each of the right and left sides of the seat can easily use the external apparatus electric connector.

The foregoing description is in all aspects illustrative and does not restrict the present invention. Numerous modifications and variations that have not yet been exemplified are devised without departing from the scope of the present invention.

1. A vehicle with an electric connector, comprising:
a car body;
wheels rotatably supported by the car body;
a traveling battery supplying travel drive power;
a seat; and
a dashboard including a dashboard body located in front of the seat and a charging electric connector supported by the dashboard body to receive electric power for the traveling battery.

2. The vehicle according to claim 1, wherein
the charging electric connector has a downward posture with respect to a horizontal direction.

3. The vehicle according to claim 2, wherein
the charging electric connector has a posture inclined with respect to a perpendicular direction.

4. The vehicle according to claim 2, wherein
an extension of an axis line of the charging electric connector intersects with a floor of the car body.

5. The vehicle according to claim 2, wherein
the dashboard body includes a first region and a second region,
an outward surface of the first region is directed downward with respect to rearward along a horizontal direction,
the second region is continuous on an upper side of the first region via an edge, and
the charging electric connector is supported at a position of having contact with the edge in the first region.

6. The vehicle according to claim 1, further comprising:
a steering control steering the wheels; and
a steering column supporting the steering control at a position on one side in a vehicle-width direction, wherein
the charging electric connector is located closer to the one side in the vehicle-width direction in relation to the steering column.

7. The vehicle according to claim 1, further comprising
a drive operation pedal located on one side in a vehicle-width direction, wherein
the charging electric connector is located closer to the one side in the vehicle-width direction in relation to the drive operation pedal.

8. The vehicle according to claim 1, further comprising
a steering control steering the wheels, wherein
the steering control is located to one of both sides in a vehicle-width direction, and
a dashboard further includes:
a driver seat-side external apparatus electric connector supported by the dashboard body on a side closer to the steering control in relation to a middle in the vehicle-width direction; and
a passenger seat-side external apparatus electric connector supported by the dashboard body on a side opposite to the steering control in relation to the middle in the vehicle-width direction.

9. The vehicle according to claim 8, wherein
the driver seat-side external apparatus electric connector is located on an outer side of the steering control in the vehicle-width direction.

10. The vehicle according to claim 8, wherein
the dashboard body includes a passenger seat-side storage located on a side opposite to the steering control in the vehicle-width direction, and
a connection port of the passenger seat-side external apparatus electric connector is located in the passenger seat-side storage.

11. The vehicle according to claim 10, wherein
a connection port of the passenger seat-side external apparatus electric connector is located closer to a back side in relation to a middle of the passenger seat-side storage in a depth direction.

12. The vehicle according to claim 8, wherein
the dashboard includes a middle external apparatus electric connector supported by the dashboard body between the driver seat-side external apparatus electric connector and the passenger seat-side external apparatus electric connector in the vehicle-width direction,
the dashboard body includes a middle storage located in a middle in the vehicle-width direction, and
a connection port of the middle external apparatus electric connector is located in the middle storage, and is located closer to a rear side in relation to a connection port of the driver seat-side external apparatus electric connector or the passenger seat-side external apparatus electric connector in a frontward and rearward direction.

13. The vehicle according to claim 12, further comprising
the dashboard further includes an information apparatus located in a middle of the dashboard body in the vehicle-width direction, and
the middle external apparatus electric connector is communicably connected to the information apparatus.

14. The vehicle according to claim 8, wherein
the seat includes a seat part, a seat base supporting the seat part, and a rear side external apparatus electric connector supported in a rearward portion of the seat base.

15. The vehicle according to claim 1, further comprising
an external apparatus electric connector supported in a downward posture with respect to a horizontal direction.

16. A vehicle, comprising:
a car body;
wheels rotatably supported by the car body;
a steering control steering the wheels;
a seat located in rear of the control; and
an external apparatus electric connector including a connection port, wherein
an extension part extending to a side of an opening of the connection port in a plan view is located on an upper side of the connection port.

17. The vehicle according to claim 16, wherein
the external apparatus electric connector includes a housing enclosing the connection port,
the external apparatus electric connector has a downward posture with respect to a horizontal direction, and
a portion of the housing located on an upper side of the connection port is the extension part.

18. The vehicle according to claim 16, further comprising
a storage forming a space housing an object, wherein
the external apparatus electric connector is located in the storage, and
at least a part of a ceiling part of the storage is the extension part.

19. A vehicle, comprising:
a car body;
wheels rotatably supported by the car body;
a steering control located to one of both sides in a vehicle-width direction to steer the wheels;
a seat located in rear of the control; and
a dashboard including a dashboard body located in front of the seat, a driver seat-side external apparatus electric connector supported by the dashboard body on a side closer to the steering control in relation to a middle in the vehicle-width direction, and a passenger seat-side external apparatus electric connector supported by the dashboard body on a side opposite to the steering control in relation to the middle in the vehicle-width direction.
